(19) United States
(12) Patent Application Publication
(10) Pub. No.: US 2014/0054472 A1
(43) Pub. Date: Feb. 27, 2014

(54) RESIN CURING DEVICE

(71) Applicants: Hajime Tanihara, Osaka (JP); Hiroshi Matsuwaki, Osaka (JP)

(72) Inventors: Hajime Tanihara, Osaka (JP); Hiroshi Matsuwaki, Osaka (JP)

(73) Assignee: Panasonic Corporation, Osaka (JP)

(21) Appl. No.: 14/112,268

(22) PCT Filed: Apr. 1, 2013
(86) PCT No.: PCT/JP2013/002212

§ 371 Date: Oct. 17, 2013

(30) Foreign Application Priority Data
Apr. 4, 2012 (JP) 2012-085410

(51) Int. Cl. B29C 35/08

(52) U.S. Cl. CPC B29C 35/0805
USPC 250/492.1

(57) ABSTRACT

The present invention provides resin curing device for radiating light to cure light curable resins of different kinds. The device has flash lamp for emitting irradiation light in a wavelength range including at least a wavelength for curing the light curable resins of different kinds, and control section. Control section causes flash lamp to emit the light at a frequency of plural times per second, and controls a total irradiation energy of the light in the wavelength range to be not less than 0.1 J/cm² but not more than a level that cause low-temperature burn on a finger and toe. The device cures various types of light curable resins with difference in wavelength of light for curing, but also offers safety with no worry about causing low-temperature burn on the human body.

### TECHNICAL FIELD

The present invention relates to a resin curing device capable of curing light curable resin applied to fingernails and/or toenails by emitting irradiation light to the light curable resin.

### BACKGROUND ART

As decorations onto fingernails and/or toenails, applying artificial nails such as nail chips and sculptured nails to natural nails has been popular.

A gel nail, which is a type of artificial nail, uses gel containing acrylic urethane resin as a major component. The gel is a light curable resin. With irradiation of light in a specific ultraviolet range, the gel is cured and formed into artificial nails.

In forming gel nails, there are some suggestions on a resin curing device that emits light in an ultraviolet range so as to cure the gel (for example, see patent literatures 1 and 2).

A conventional resin curing device generally employs a UV lamp, such as a mercury lamp and a fluorescent lamp, and an ultraviolet light-emitting diode (hereinafter, simply referred to as UV-LED) as for a light source for curing gel.

Hereinafter, wavelength characteristics of the light source used for an ordinary resin curing device are described with reference to FIG. 4.

FIG. 4 shows light quantity distribution represented as relative values with reference to the light quantity at the peak wavelength of a light source used for an ordinary resin curing device. In FIG. 4, the broken line shows the wavelength characteristics of the UV lamp, and the dotted line shows the wavelength characteristics of the UV-LED.

As shown in FIG. 4, the light sources employed for the conventional resin curing device have a narrow range of the wavelengths of irradiation light and different peak wavelengths. For example, the UV lamp shown by the broken line in FIG. 4 has a peak wavelength of irradiation light of 370 nm, and its light quantity distribution to the peak wavelength (represented as a relative value (%) with reference to the light quantity at the peak wavelength) exhibits a steep curve.

Similarly, the UV-LED shown by the dotted line in FIG. 4 has a peak wavelength of irradiation light of 405 nm, and its light quantity distribution with reference to the peak wavelength exhibits, too, a steep curve.

That is, a UV-lamp curable gel can be cured by a resin curing device having a UV-lamp; however, the UV-lamp curable gel cannot be cured well by a resin curing device having a UV-LED. Because the two light sources have difference in peak wavelengths and have a small overlap between the ranges of wavelength, the amount of light in the required wavelength range is not enough for curing the UV-lamp curable resin. With the resin curing device having the UV-LED, the UV-lamp curable gel cannot be sufficiently cured, or it takes a long time for curing.

Conversely, when a resin curing device having a UV-lamp is used for curing UV-LED curable gel, the similar problem arises.

That is, a conventional resin curing device has the problem—whether a light curable resin is properly cured or not is determined by the light source mounted on the resin curing device.

A xenon flash lamp (hereinafter, simply referred to a Xe lamp) is generally used for the light source for curing light curable resin (see patent literature 3, for example). As shown by the solid line in FIG. 4, the Xe lamp emits light that includes the peak wavelengths of the ITV lamp and the UV-LED. Further, the Xe lamp retains light irradiation energy of a light-sensitive wavelength—by which different light curable resins, i.e., a UV-lamp curable resin and a UV-LED curable resin can be cured—at a level of 60% or greater of the peak wavelength. Therefore, both the UV-lamp curable resin and the UV-LED curable resin can be sufficiently cured in a short time by the Xe lamp.

Besides, the Xe lamp described in patent literature 3 is the light source not only for curing gel but also for curing ordinary light curable resin. Therefore, when the Xe lamp is used as the light source of a resin curing device, the resin curing device has a structure capable of blocking the wavelength belonging to an ultraviolet range so as to irradiate light with a light-sensitive wavelength only.

Such structured resin curing device with the Xe lamp reduces the adverse effect of ultraviolet light on the human body.

However, in decorating nails, the fingertips have to undergo light irradiation for a predetermined time. When the Xe lamp is used for the nail decoration, the Xe lamp can cause low-temperature burn on the fingertips. The Xe lamp has the advantage of coping with light curable resins having difference in wavelength of light required for curing; on the other hand, the lamp has a problem of causing low-temperature burn on the human body.

Considering above, there has been a demand for manufacturing a resin curing device capable of not only curing various types of light curable resins with difference in wavelength of light required for curing, but also offering safety with no worry about causing low-temperature burn on the human body.

### CITATION LIST

### Patent Literature

### PTL 1

Japanese Registered Utility Model No. 3151698

### PTL 2

Japanese Unexamined Patent Application Publication No. 2011-98073

### PTL 3

Japanese Unexamined Patent Application Publication No. 2011-76825

### SUMMARY OF THE INVENTION

To address the problem above, the present invention provides a resin curing device capable of irradiating light to cure light curable resins of different kinds applied to any of a fingernail and/or a toenail. The resin curing device has a flash lamp for emitting irradiation light in a wavelength range including at least a wavelength for curing the light curable resins of different kinds, and a control section. The control section causes the flash lamp to emit the light at a frequency of plural times per second, and controls a total irradiation energy of the light in the wavelength range to be not less than 0.1 J/cm² but not more than a level that cause low-temperature burn on a finger and toe.

The structure above allows different types of light curable resins to be cured by a single resin curing device.

Further, maintaining the total irradiation energy of the wavelength range of irradiation light not less than 0.1 J/cm² allows light curable resin to be cured in a short time.

Still further, the resin curing device enhances safety, i.e., offers no worry about causing low-temperature burn on the human body.

### BRIEF DESCRIPTION OF DRAWINGS

FIG. 1 is a cross-section view of the resin curing device in accordance with an exemplary embodiment of the present invention.

FIG. 2 shows a relationship between surface temperature of a resin material to be irradiated and total irradiation energy of light in the wavelength range of irradiation light fed from the resin curing device in accordance with the exemplary embodiment.

FIG. 3 shows evaluation results of product A through product G having undergone light irradiation by the resin curing device in accordance with the exemplary embodiment.

FIG. 4 shows light quantity distribution represented as relative values with reference to the light quantity at the peak wavelength of a light source used for an ordinary resin curing device.

### DESCRIPTION OF EMBODIMENTS

Hereinafter, the resin curing device of the exemplary embodiment of the present invention is described with reference to accompanying drawings. It will be understood that the present invention is not limited to the exemplary embodiment.

### Exemplary Embodiment

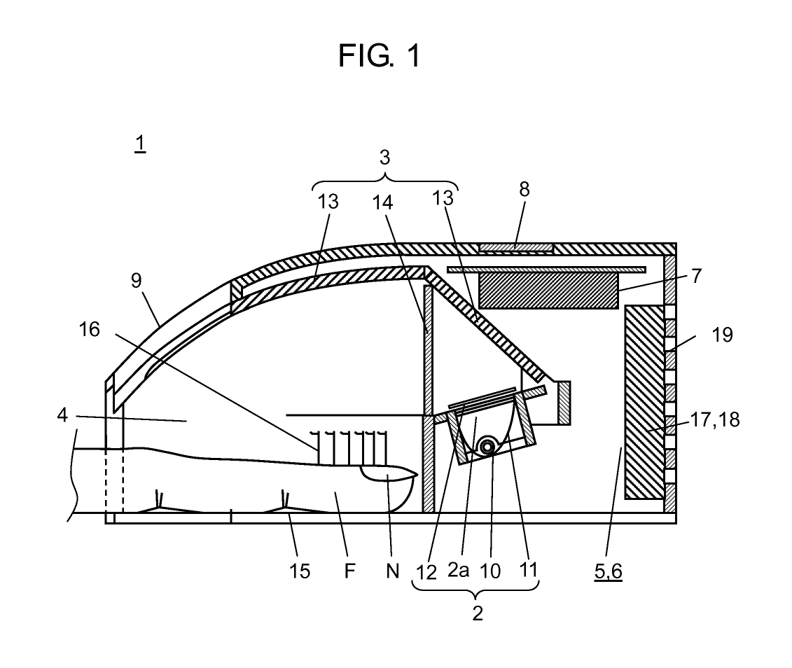

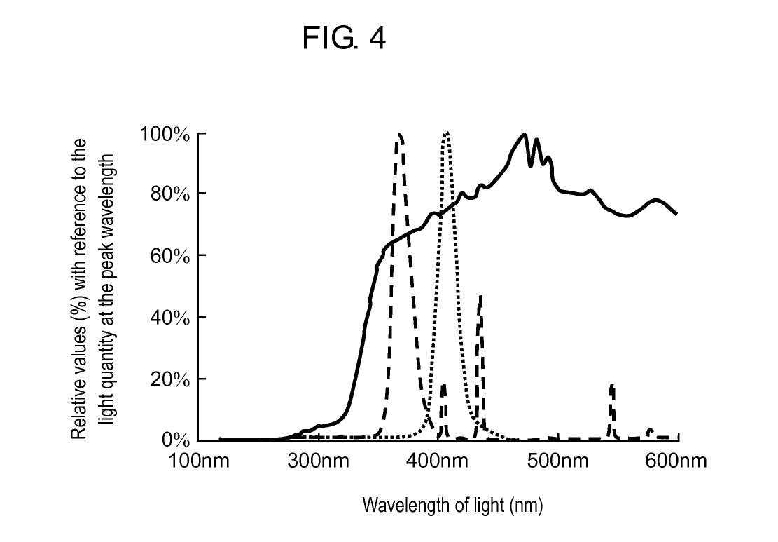

Hereinafter, the resin curing device of the exemplary embodiment of the present invention is described with reference to FIG. 1 and FIG. 4.

FIG. 1 is a cross-section view of the resin curing device in accordance with the exemplary embodiment of the present invention. FIG. 4 shows light quantity distribution represented as relative values with reference to the light quantity at the peak wavelength of a light source used for an ordinary resin curing device.

As shown in FIG. 1, resin curing device 1 of the exemplary embodiment has at least light-emitting section 2, optical system 3, irradiation chamber 4, dryer 5, cooling section 6, control section 7, operating section 8, and housing 9 for accommodating the aforementioned components. Light-emitting section 2 emits irradiation light for curing light curable resin (not shown) such as gel applied to nail N. Optical system 3 guides the irradiation light to light curable resin applied to nail N. Fingertip F is inserted in irradiation chamber 4 where nail N undergoes light irradiation. Dryer 5 dries light curable resin applied to nail N. Cooling section 6 cools down light-emitting section 2. Control section 7 performs at least light-emission control (for example, by the frequency of light irradiation and light-emitting time) of light-emitting section 2. Operating section 8 accepts input operation for operating control section 7.

Light-emitting section 2 is formed of at least flash lamp 10, reflection member 11, and light-blocking section 12. Flash lamp 10 emits light of a wavelength range at least including a wavelength required to cure light curable resins of different kinds. With the structure above, various types of light curable resins with difference in wavelength for curing can be cured by light emission of single flash lamp 10. Reflection member 11 reflects off the light emitted from flash lamp 10 toward light-blocking section 12. Light-blocking section 12 cuts off light included in a specific range (for example, the infrared-light range) in the irradiation light fed from flash lamp 10.

Flash lamp 10 of light-emitting section 2 is formed of, for example, a xenon discharge tube capable of emitting light with a wide range of wavelengths from ultraviolet light to infrared light.

Ultraviolet light falls into following three ranges based on the wavelength: ultraviolet A-range (UV-A) as the first range includes light with a wavelength not less than 320 (or 315) nm and not more than 400 nm; ultraviolet B-range (UV-B) as the second range includes light with a wavelength not less than 280 nm and less than 320 (or 315) nm; and ultraviolet C-range (UV-C) as the third range includes light with a wavelength not less than 100 nm and less than 280 nm. The shorter the wavelength of ultraviolet becomes, the higher the risk of injury to the human body becomes. Considering above, the irradiation light should not preferably contain ultraviolet light close to the UV-C range. Flash lamp 10 of the exemplary embodiment emits light with a wavelength belonging to the ranges of UV-A and UV-B out of the aforementioned three ranges.

According to resin curing device 1 of the exemplary embodiment, flash lamp 10 emits light two or more times per second. Specifically, flash lamp 10 emits light at least twice per second so as to cure light curable resin.

Flash lamp 10 should preferably emit light not more than 100 times (100 Hz) per second to protect flash lamp 10 from an excessive load. As a result, flash lamp 10 offers its long operating life and high reliability. This has been demonstrated at least under the condition that flash lamp 10 emits light with the total irradiation energy of the wavelength range of irradiation light not less than 0.1 J/cm² and not more than 5.0 J/cm².

According to resin curing device 1 of the exemplary embodiment, flash lamp 10 emits light so as to maintain the total irradiation energy of the wavelength range of irradiation light not less than 0.1 J/cm², but so as not to reach the degree that can cause low-temperature burn on the fingertips. Specifically, to protect fingertips from low-temperature burn, flash lamp 10 emits light with the total irradiation energy of the required wavelength range of irradiation light not more than 5.0 J/cm².

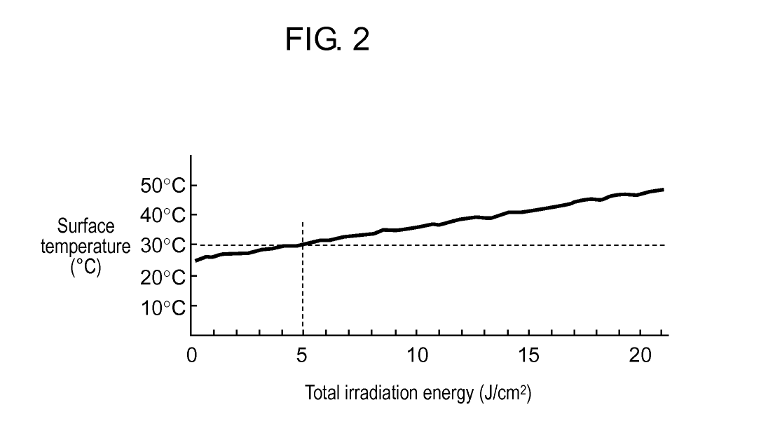

Hereinafter, the reason why the total irradiation energy of irradiation light in the required wavelength range is determined not more than 5.0 J/cm² will be described with reference to FIG. 2.

FIG. 2 shows a relationship between surface temperature of a resin material to be irradiated and total irradiation energy of light in the wavelength range of irradiation light fed from the resin curing device in accordance with the exemplary embodiment. The “light in the wavelength range of irradiation light” above means light belonging to a range that is not blocked by a UV-B cut filter and an infrared cut filter (that will be described later).

As is apparent from FIG. 2, when the total irradiation energy of light in the wavelength range of irradiation light is 5.0 J/cm² or less, the surface temperature of gel (as an object to be irradiated) applied to fingernails has a rise less than 5° C. from 25° C. Even when the skin around the nails with a surface temperature of 36-37° C., for example, has a rise of 5° C., the surface temperature stays around 41-42° C. That is, when light curable resin (for example, gel having an average film thickness of 20-40 μm) applied to fingernails undergoes light irradiation with a total irradiation energy not more than 5.0 J/cm², the surface temperature of the skin of fingertips is unlikely to exceed 43° C.—at which, it is generally believed that low-temperature burn develops within hours. This indicates that the light irradiation of the embodiment enhances safety having low risk for causing low-temperature burn.

As shown in FIG. 1, flash lamp 10 has a lengthy form in the direction vertical to the sheet of paper having FIG. 1. Reflection member 11 of light-emitting section 2 is formed into a half-round shape along the lengthwise direction of flash lamp 10. The inner surface of reflection member 11 reflects off the light emitted from flash lamp 10. Having flash lamp 10 inside, reflection member 11 is disposed such that irradiation light passes through opening 2a formed along the lengthwise direction.

Light-blocking section 12 is formed of a UV-B cut filter for blocking light that belongs to the UV-B range and an infrared cut filter for blocking light that belongs to the infrared range. Light-blocking section 12 is disposed so as to cover opening 2a of reflection member 11. Of the irradiation light fed from flash lamp 10, light-blocking section 12 blocks light belonging to the infrared range and the UV-B range, while transmitting light belonging to the UV-A range and the visible light range. That is, light-blocking section 12 corresponds to an infrared-light blocking section.

The lower limit of the transmission wavelength range of light-blocking section 12 is set to 320 nm or more; preferably, 340 nm or more; and more preferably, 360 nm or more. The upper limit of the transmission wavelength range of light-blocking section 12 is set to 450 nm or less; preferably, 430 nm or less; and more preferably, 410 nm or less.

When the lower limit of the transmission wavelength range of light-blocking section 12 is set to 360 nm or more, the peak wavelength of the UV lamp (i.e. 370 nm) and the peak wavelength of the UV-LED (i.e. 405 nm) in FIG. 4 are both included in the transmission range. Similarly, when the upper limit of the transmission wavelength range of light-blocking section 12 is set to 410 nm or less, the peak wavelength of the UV lamp (i.e. 370 nm) and the peak wavelength of the UV-LED (i.e. 405 nm) in FIG. 4 are both included in the transmission range.

With the setting above, the irradiation light fed from flash lamp 10 sufficiently cures different types of light curable resins of different kinds used for gel in a short time.

Optical system 3 is formed of at least reflection member 13 and Fresnel panel 14. Reflection member 13 reflects off the irradiation light emitted from light-emitting section 2 toward the object to be irradiated. Fresnel panel 14 transmits and diffuses the light at least including light of the UV-A range out of the irradiation light emitted from light-emitting section 2.

Irradiation chamber 4 has a space in which fingertip F with light curable resin applied to nail N is inserted, and has fingertip base 15 on which fingertip F is positioned so as to have light irradiation by light emitted from light-emitting section 2.

Dryer 5 has a plurality of blow outlets 16 for blowing air into irradiation chamber 4 and fan 17 for blowing air via blow outlets 16 into irradiation chamber 4. Dryer 5 provides nail N with air by fan 17 through blow outlets 16 formed in irradiation chamber 4. The air blow accelerates evaporation of an organic solvent of the light curable resin applied to nail N, drying the light curable resin faster.

Cooling section 6 has cooling fan 18 for cooling down flash lamp 10. Cooling fan 18 of the exemplary embodiment is a component shared with fan 17 of dryer 5. Cooling fan 18 captures air from the outside of housing 9 and blows it into the inside of housing 9 in which flash lamp 10 is disposed. After cooling flash lamp 10, the air is carried into irradiation chamber 4 through blow outlets 16.

Control section 7 determines at least any one of the followings: the total irradiation energy of irradiation light in the required wavelength range; the frequency of irradiation per second; the irradiation energy of irradiation light belonging to the wavelength range per emission; and the irradiation time. Control section 7 stores predetermined setting values of the aforementioned conditions according to each type and thickness of light curable resin of gel so as to be suitable for an irradiation mode.

Operating section 8 has at least a power switch, an irradiation-mode selecting switch, a start switch, and display (not shown). The power switch turns on/off resin curing device 1. The irradiation-mode selecting switch selects the irradiation mode controlled by control section 7. When the start switch is turned on, flash lamp 10 of light-emitting section 2 starts light emission. The display displays, for example, information items of the irradiation mode.

As shown in FIG. 1, housing 9 has intake hole 19 formed as a through-hole between the inside and the outside of housing 9. Captured through intake through-hole 19, air is taken into the inside by fan 17. At that time, intake hole 19 also functions as an air passage for guiding the air taken by fan 17 to light-emitting section 2.

Resin curing device 1 of the exemplary embodiment has the structure above.

Hereinafter, the workings of the resin curing device of the exemplary embodiment will be described with reference to FIG. 1.

First, light curable resin (i.e. gel) is applied to nail N. The gel contains, for example, monomer, oligomer, photo polymerization initiator, and pigment. Pressing the power switch in operating section 8, the user turns on resin curing device 1 and then selects an irradiation mode.

After the completion of selecting the irradiation mode, the user inserts fingertip F into irradiation chamber 4 and puts fingertip F on fingertip base 15. In this way, nail N is located at a light-irradiating position on fingertip base 15.

Next, the user presses the start switch in operating section 8 to start light irradiation. Control section 7 causes flash lamp 10 to emit light according to the irradiation mode selected in operating section 8. Of irradiation light emitted from flash lamp 10, light-blocking section 12 of light-emitting section 2 blocks light belonging to the UV-B range and the infrared range, while transmitting light belonging to the UV-A range (including a required wavelength range) and the visible light range. The transmitted light reflects off reflection member 13 of optical system 3 and then passes through Fresnel panel 14.

Placed on fingertip base 15 in irradiation chamber 4, nail N of fingertip F undergoes light irradiation by the light in the required wavelength range transmitted through Fresnel panel 14. The light irradiation allows light curable resin—regardless of specifications on curing, i.e., regardless of whether UV-LED curable gel or UV-lamp curable gel—to be cured. In the light irradiation, as described earlier, the irradiation light is controlled so as to have the total irradiation energy of irradiation light in the required wavelength range not less than 0.1 J/cm², so that light curable resin applied to nail N is cured.

A preferable amount of total irradiation energy will be described later with reference to an experimental example.

The irradiation light for curing light curable resin applied to nail N does not contain light with a wavelength shorter than that included in the UV-B range. Therefore, if fingertip F around nail N is exposed to the irradiation light transmitted through Fresnel panel 14, the light irradiation assures safety of skin against being irradiated with ultraviolet. Besides, the irradiation light contains no infrared-range light, which suppresses a temperature rise of 5° C. or more of fingertip F. As a result, the light irradiation assures safety the skin of fingertip F against low-temperature burn.

### EXAMPLE

The resin curing device of the exemplary embodiment will be described in detail with reference to an example.

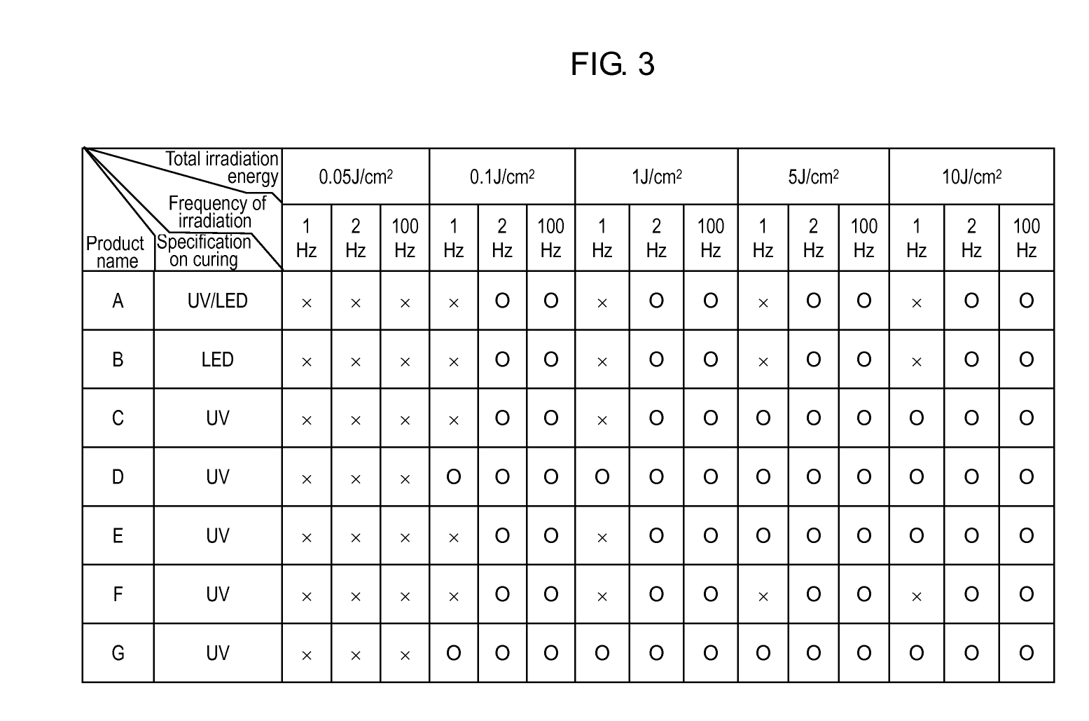

With use of resin curing device 1 of the exemplary embodiment, a curing test on light curable resin was carried out. As for the light curable resin, commercially available product A through product G were employed. The experiment result on evaluation of the products will be described with reference to FIG. 3. Specifically, the products are as follows: GELeration (red) for product A; Presto (red) for product B; Bio sculpture (black) for product C; Calgel (pink) for product D; Gelish (red) for product E; PREGEL (red) for product F; and OPI Axxium (red) for product G. The product names mentioned above are registered trademarks in Japan.

First, in the evaluation on curing of product A through product G, irradiation time of light of resin curing device 1 was determined 20 seconds as fixed condition, and the total irradiation energy of irradiation light in the required wavelength range and the frequency of light irradiation were employed for parameters. In the evaluation, the total irradiation energy of irradiation light in the required wavelength range (as one of the parameters) was evaluated for the following five patterns: 0.05 J/cm²; 0.1 J/cm²; 1 J/cm²; 5 J/m²; and 10 J/cm².

The frequency of light irradiation was evaluated for the following three patterns: 1 Hz; 2 Hz, and 100 Hz. The light-emitting time per frequency was determined to 200 μs. The frequency of light irradiation represents the frequency per second and its measurement unit is Hz. A frequency of light irradiation of 1 Hz means one-time irradiation per second, and a frequency of light irradiation of 100 Hz means 100-time irradiation per second.

In FIG. 3, “UV” (in the column of specification on curing) means UV-lamp curable resin and “LED” means UV-LED curable resin. “UV/LED” means light curable resin curable by both of the UV-lamp and the UV-LED. Products C through G are basically UV-lamp curable resin but have difference in composition and material contained therein.

FIG. 3 shows the evaluation result of each product by the mark “o” or “x”. The mark “o” shows that the cured state of the resin reached or exceeded the curing standard obtained by a conventional method, whereas the mark “x” shows that the resin was uncured.

Hereinafter, the evaluation results of light curable resin (of product A through product G) under the aforementioned condition will be specifically described with reference to FIG. 3.

FIG. 3 shows evaluation results of product A through product G having undergone light irradiation by the resin curing device of the exemplary embodiment.

First, the result of the light curable resin of product A as a UV/LED curable resin was as follows. Under the condition of the total irradiation energy of 0.1 J/cm², 1 J/cm², 5 J/cm², and 10 J/cm², the light curable resin of product A hardened at a frequency of light irradiation of 2 Hz and 100 Hz, but did not harden at a frequency of light irradiation of 1 Hz. Under the condition of the total irradiation energy of 0.05 J/cm², the light curable resin of product A did not harden at any one of the frequency of light irradiation of 1 Hz, 2 Hz, and 100 Hz.

Next, the result of the light curable resin of product B as a UV-LED curable resin was as follows. Under the condition of the total irradiation energy of 0.1 J/cm², 1 J/cm², 5 J/cm², and 10 J/cm², the light curable resin of product B hardened at a frequency of light irradiation of 2 Hz and 100 Hz, but did not harden at a frequency of light irradiation of 1 Hz. Under the condition of the total irradiation energy of 0.05 J/cm², the light curable resin of product B did not harden at any one of the frequency of light irradiation of 1 Hz, 2 Hz, and 100 Hz.

Next, the result of the light curable resin of product C as a UV-lamp curable resin was as follows. Under the condition of the total irradiation energy of 0.1 J/cm², 1 J/cm², 5 J/cm², and 10 J/cm², the light curable resin of product C hardened at a frequency of light irradiation of 2 Hz and 100 Hz. Under the condition of the total irradiation energy of 5 J/cm² and 10 J/cm², the light curable resin of product C hardened at a frequency of light irradiation of 1 Hz. However, under the condition of the total irradiation energy of 0.1 J/cm² and 1 J/cm², the light curable resin of product C did not harden at a frequency of light irradiation of 1 Hz. Under the condition of the total irradiation energy of 0.05 J/cm², the light curable resin of product C did not harden at any one of the frequency of light irradiation of 1 Hz, 2 Hz, and 100 Hz.

Next, the result of the light curable resin of product D as a UV-lamp curable resin was as follows. Under the condition of the total irradiation energy of 0.1 J/cm², 1 J/cm², 5 J/cm², and 10 J/cm², the light curable resin of product D hardened at a frequency of light irradiation of 1 Hz, 2 Hz, and 100 Hz. However, under the condition of the total irradiation energy of 0.05 J/cm², the light curable resin of product D did not harden at any one of the frequency of light irradiation of 1 Hz, 2 Hz, and 100 Hz.

Next, the result of the light curable resin of product E as a UV-lamp curable resin was as follows. Under the condition of the total irradiation energy of 0.1 J/cm², 1 J/cm², 5 J/cm², and 10 J/cm², the light curable resin of product C hardened at a frequency of light irradiation of 2 Hz and 100 Hz. Under the condition of the total irradiation energy of 5 J/cm² and 10 J/cm², the light curable resin of product E hardened at a frequency of light irradiation of 1 Hz. However, under the condition of the total irradiation energy of 0.1 J/cm² and 1 J/cm², the light curable resin of product E did not harden at a frequency of light irradiation of 1 Hz. Further, under the condition of the total irradiation energy of 0.05 J/cm², the light curable resin of product E did not harden at any one of the frequency of light irradiation of 1 Hz, 2 Hz, and 100 Hz.

Next, the result of the light curable resin of product F as a UV-lamp curable resin was as follows. Under the condition of the total irradiation energy of 0.1 J/cm², 1 J/cm², 5 J/cm², and 10 J/cm², the light curable resin of product F hardened at a frequency of light irradiation of 2 Hz and 100 Hz, but did not harden at a frequency of light irradiation of 1 Hz. Under the condition of the total irradiation energy of 0.05 J/cm², the light curable resin of product F did not harden at any one of the frequency of light irradiation of 1 Hz, 2 Hz, and 100 Hz.

Next, the result of the light curable resin of product G as a UV-lamp curable resin was as follows. Under the condition of the total irradiation energy of 0.1 J/cm², 1 J/cm², 5 J/cm², and 10 J/cm², the light curable resin of product G hardened at a frequency of light irradiation of 1 Hz, 2 Hz, and 100 Hz. However, under the condition of the total irradiation energy of 0.05 J/cm², the light curable resin of product G did not harden at any one of the frequency of light irradiation of 1 Hz, 2 Hz, and 100 Hz.

As is apparent from the results of the total irradiation energy and the frequency of light irradiation shown in FIG. 3, when the total irradiation energy of the same wavelength range (for example, from 0.1 J/cm² to 10 J/cm²) is fed to light curable resin, applying the energy in small quantity in several times (i.e., the frequency of irradiation of 2 Hz and 100 Hz) is more effective in thoroughly curing the light curable resin than applying the energy in large quantity at one time (i.e., the frequency of irradiation of 1 Hz). This may be attributed to a characteristic that photopolymerization initiator contained in light curable resin loses light absorptive capacity as it absorbs irradiation light. When a large amount of irradiation energy is applied to light curable resin at one time (i.e., at frequency of irradiation of 1 Hz), the surface of the light curable resin hardens by light irradiation and the hardened layer of the surface blocks light transmission, so that the inside of the light curable resin does not harden.

When irradiation light in the required wavelength range have a total irradiation energy exceeding 5 J/cm², the light curable resin of all the products (products A through G) hardened. However, as described above, the total irradiation energy exceeding 5 J/cm² can cause 5° C.-or-more rise of surface temperature of the skin exposed to the light irradiation. That is, irradiation light with a total irradiation energy exceeding 5 J/cm² can cause low-temperature burn on the part of human body exposed to the light, and therefore it is not preferable in the resin curing device of the exemplary embodiment.

Besides, when the flash lamp emits light at a frequency of irradiation of 100 Hz or more, the glass of the flash lamp deteriorates due to a load such as a thermal impact, generating a crack. This eventually develops a leak, resulting in short lifespan of the flash lamp. Considering above, the inventor judged that it would be inappropriate—regardless of the setting value of the total irradiation energy of irradiation light in the required wavelength range—to the resin curing device of the exemplary embodiment. This is the reason why FIG. 3 has no evaluation results on the frequency of light irradiation of 100 Hz or more.

Through the evaluation, the inventor concludes that the following setting are preferable for curing light curable resin such as gel applied to nail N: the total irradiation energy of irradiation light in the required wavelength range not less than 0.1 J/cm² and not more than 5 J/cm²; and the frequency of light irradiation not less than 2 Hz and not more than 100 Hz.

In the example above, the light-irradiation time is determined to 20 seconds, but it is not limited to. For instance, as long as the total irradiation energy of irradiation light in the required wavelength range and the frequency of light irradiation are determined in the preferable ranges above, making a change to the irradiation energy applied at one time allows the light-irradiation time to have any given value.

According to the exemplary embodiment, as described above, flash lamp 10 of light-emitting section 2 emits irradiation light belonging to the wavelength range capable of curing light curable resins of different types. With the structure above, resin curing device 1 cures light curable resin according to difference in types of light curable resin.

Besides, flash lamp 10 of light-emitting section 2 of the exemplary embodiment is a light source that emits light more than once per second and has a large amount of instantaneous light emission, by which light curable resin are cured in a short time. Compared to a resin curing device with a conventional UV-lamp or UV-LED as a light source (that needs the irradiation time ranging from 30 seconds to three minutes), resin curing device 1 of the exemplary embodiment shortens the irradiation time. The flash lamp offers the total irradiation energy in a short time. In contrast, the UV-lamp and the UV-LED offer the energy so as not to exceed the predetermined maximum value, and therefore they take a period of time for applying the amount of energy the same as that applied by the flash lamp. Applying the total irradiation energy of irradiation light in the required wavelength range not less than 0.1 J/cm² allows light curable resin to be cured in a short time. When an ordinary UV-LED and a UV-lamp are used, the curing time of the aforementioned products ranges from 30 seconds to three minutes. In contrast, when the flash lamp is used, the curing time is shortened to 20 seconds that are not enough for curing the products by the ordinary way.

Besides, applying the total irradiation energy of irradiation light in the required wavelength range not more than 5 J/cm² protects the fingertips from having low-temperature burn. The resin curing device with high safety is thus obtained.

According to the exemplary embodiment, if the irradiation light fed from flash lamp 10 of light-emitting section 2 includes light in the infrared range other than the required wavelength range, the light of the infrared range is blocked by light-blocking section 12 so as not to expose the fingertips to light of the infrared range. The structure protects the fingertips from having low-temperature burn, enhancing safety.

According to the exemplary embodiment, fan 17 blows air through blow outlets 16 into irradiation chamber 4 and dries light curable resin applied to nail N of fingertip F inserted in irradiation chamber 4. The air blow is also effective in further shortening the curing time.

According to the exemplary embodiment, cooling fan 18 cools down flash lamp 10 heated up easily by repeated light emission. This increases reliability (, for example, operating life) and suppresses temperature rise in housing 9.

According to the exemplary embodiment, control section 7 controls irradiation light in a manner that light curable resins of different types undergo light irradiation under respectively optimum condition (i.e., the total irradiation energy of irradiation light in the required wavelength range, the frequency of irradiation per second, the irradiation energy per emission, and irradiation time). This provides the resin curing device with general versatility.

According to the exemplary embodiment, a xenon discharge tube is employed for flash lamp 10 as the light source of light-emitting section 2. Compared to a resin curing device generally employing a mercury lamp and a fluorescent lamp for the light source, the resin curing device of the exemplary embodiment can be easily formed into a compact structure. By virtue of reduction in size, the resin curing device offers high portability, ease of installation, and convenience for users.

It is to be understood that the resin curing device of the present invention is not limited to the structure described in the exemplary embodiment but is susceptible of various changes without departing from the scope of the present invention.

For instance, the exemplary embodiment describes an example where light irradiation is used for decorating nail N of fingers, but it is not limited to. The resin curing device may be structured so as to emit irradiation light for decorating toenails. Such structured device offers effect similar to the case where light irradiation is used for fingertip F of finger.

As described above, the present invention provides a resin curing device capable of irradiating light to cure light curable resins of different kinds applied to any of a fingernail and/or a toenail. The resin curing device has a flash lamp for emitting irradiation light in a wavelength range including at least a wavelength for curing the light curable resins of different kinds, and a control section. The control section effects control of the flash lamp in a manner so as to emit irradiation light two or more times per second. At the same time, the control section controls the light emission of the flash lamp so as to maintain the total irradiation energy of irradiation light in the wavelength range not less than 0.1 J/cm², but so as not to reach the degree that can cause low-temperature burn on the fingertip and the toe.

According to the structure, the flash lamp emits light of wavelength range including a wavelength to cure light curable resins of different types so as to cure respective light curable resin. The structure above allows light curable resins of different types to be cured by a single resin curing device.

Besides, the flash lamp emits light more than once per second and has a large amount of instantaneous light emission. The flash lamp is a light source suitable for curing light curable resin in a short time. Besides, applying the total irradiation energy of irradiation light of the wavelength range not less than 0.1 J/cm² allows light curable resin to cure in a short time. Further, the resin curing device controls the total irradiation energy of irradiation light so as not to cause low-temperature burn on the fingertip or the toe. With the structure, the resin curing device enhances safety with no worry about causing low-temperature burn on the human body.

Besides, the resin curing device of the present invention offers the total irradiation energy of irradiation light in the required wavelength range not more than 5.0 J/cm².

According to the structure, controlling the total irradiation energy of irradiation light in the wavelength range emitted from the flash lamp so as not to exceed 5.0 J/cm² allows light curable resin to have curing condition suitable for each difference in types of light curable resins, protecting the skin of the human body exposed to the light from low-temperature burn. As a result, the resin curing device cures light curable resin with reliability and offers high safety.

Further, according to the resin curing device of the present invention, the frequency of irradiation by the flash lamp is not more than 100 times per second. The structure allows light curable resins with difference in type to have effective curing in a short time.

Besides, when the irradiation light includes light in the infrared range, the resin curing device of the present invention may contain an infrared blocking section for blocking light included in the infrared range.

With the structure above, if the irradiation light includes light in the infrared range other than the required wavelength range, the infrared blocking section blocks the infrared-range light before irradiation on the human body. Therefore, the structure protects the skin of the human body from low-temperature burn, enhancing safety.

Further, the resin curing device of the present invention may contain an irradiation chamber in which at least the fingers with light curable resin applied to the nails are inserted, and a dryer for drying the light curable resin applied to the fingernails inserted in the irradiation chamber. Further, the dryer may contain a fan for blowing air into the irradiation chamber and a blow outlet through which the air is fed into the irradiation chamber.

With the structure, the air is carried through the blow outlet to the fingertips, which is effective in drying the light curable resin applied to any of the fingernail and/or toenail inserted in the irradiation chamber.

Further, the resin curing device of the present invention may contain a housing for accommodating the irradiation chamber and the dryer, and a cooling section disposed in the housing to cool down the flash lamp.

With the structure, the cooling section such as a cooling fan cools down the flash lamp—it is easy to heat up by repeated light emission—and the inside of the housing. This increases reliability, for example, the operating life of the flash lamp.

Further, the resin curing device of the present invention may carry out emission control of the flash lamp by determining at least one of the followings: the total irradiation energy of irradiation light in the required wavelength range; the frequency of irradiation per second; the irradiation energy per emission; and irradiation time.

With the structure above, light curable resins of different types undergo light irradiation under respectively optimum condition (i.e., the total irradiation energy of irradiation light in the required wavelength range, the frequency of irradiation per second, the irradiation energy per emission, and irradiation time). The structure allows light curable resins with difference in type to have effective curing, offering a high level of safety.

### INDUSTRIAL APPLICABILITY

The present invention is useful for a resin curing device capable of not only curing various types of light curable resins with difference in wavelength of light for curing, but also offering safety with no worry about causing low-temperature burn on the human body.

### REFERENCE MARKS IN THE DRAWINGS

1 resin curing device
2 light-emitting section
2a opening
3 optical system
4 irradiation chamber
5 dryer
6 cooling section
7 control section
8 operating section
9 housing
10 flash lamp
11 reflection member
12 light-blocking section
13 reflection member
14 Fresnel panel
15 fingertip base
16 blow outlet
17 fan
18 cooling fan
19 intake hole

1. A resin curing device for radiating light to cure light curable resins of different kinds applied to any of a fingernail and/or a toenail, the device comprising:
a flash lamp for emitting irradiation light in a wavelength range including at least a wavelength for curing the light curable resins of different kinds; and
a control section,
wherein, the control section causes the flash lamp to emit the light at a frequency of plural times per second, and controls a total irradiation energy of the light in the wavelength range to be not less than 0.1 J/cm² but not more than a level that cause low-temperature burn on a finger and toe.

2. The resin curing device of claim 1, wherein the total irradiation energy of the irradiation light in the wavelength range is not more than 5.0 J/cm².

3. The resin curing device of claim 1, wherein the frequency of irradiation of the flash lamp is not more than 100 times per second.

4. The resin curing device of claim 1, wherein when the irradiation light includes infrared-range light, an infrared blocking section for blocking the infrared-range light is additionally disposed.

5. The resin curing device of claim 1 including:
an irradiation chamber in which at least the fingertips with the light curable resin applied to the nails are inserted; and
a dryer for drying the light curable resin applied to the nails of the fingertips inserted in the irradiation chamber, the dryer further including:
a fan for blowing air into the irradiation chamber; and
a blow outlet for blowing the air into the irradiation chamber.

6. The resin curing device of claim 5 including:
a housing for accommodating the irradiation chamber and the dryer; and
a cooling section disposed in the housing, the cooling section for cooling down the flash lamp.

7. The resin curing device of claim 1, wherein the control section performs emission control of the flash lamp by determining at least one of the total irradiation energy of the irradiation light in the wavelength range, the frequency of irradiation per second, irradiation energy per emission, and irradiation time.
